(19) United States
(12) Patent Application Publication
(10) Pub. No.: US 2019/0009349 A1
(43) Pub. Date: Jan. 10, 2019

(54) MULTIPLE MILLING BITS MILLING MACHINE

(71) Applicant: HEWLETT-PACKARD DEVELOPMENT COMPANY, L.P., Houston, TX (US)

(72) Inventors: Matthew G. LOPEZ, San Diego, CA (US); Kim Kamikawa LOPEZ, San Diego, CA (US); Edward PONOMAREV, San Diego, CA (US); Marvin Dav HOAG, San Diego, CA (US)

(73) Assignee: HEWLETT-PACKARD DEVELOPMENT COMPANY, L.P., Houston, TX (US)

(21) Appl. No.: 16/081,234

(22) PCT Filed: Sep. 13, 2016
(86) PCT No.: PCT/US2016/051446

§ 371 Date: Aug. 30, 2018

(51) Int. Cl. B23C 1/08; B23C 1/00

(52) U.S. Cl. CPC B23C 1/08; B23C 1/002

(57) ABSTRACT

An example milling machine includes a base and a receiving platform mounted to the base to receive a first workpiece and a second workpiece. The receiving platform is moveable along a first axis. The milling machine also includes a support platform mounted to the base, a first plurality of milling bits to cut the first workpiece, and a second plurality of milling bits to cut the second workpiece. The first plurality of milling bits and the second plurality of milling bits are moveable along a second axis via the support platform. Each milling bit of the first plurality of milling bits and the second plurality of milling bits is to move along a third axis independently.

### BACKGROUND

When manufacturing a product, the unfinished product may be shaped or machined for further processing. A variety of tools may be used to shape or machine the unfinished product.

### BRIEF DESCRIPTION OF THE DRAWINGS

Some examples of the present application are described with respect to the following figures:

FIG. 1 illustrates a block diagram of a milling machine with a first plurality of milling bits to cut a first workpiece and a second plurality of milling bits to cut a second workpiece, according to an example;

FIG. 2 illustrates an isometric view of a milling machine with a first plurality of milling bits to cut a first workpiece and a second plurality of milling bits to cut a second workpiece, according to an example;

FIG. 3 illustrates a block diagram of controller of a milling machine with a first plurality of milling bits to cut a first workpiece and a second plurality of milling bits to cut a second workpiece, according to an example;

FIG. 4 illustrates a method of operation at a milling machine with a first plurality of milling bits to cut a first workpiece and a second plurality of milling bits to cut a second workpiece, according to an example; and

FIG. 5 illustrates a method of determining cut paths of milling bits at a milling machine with a first plurality of milling bits to cut a first workpiece and a second plurality of milling bits to cut a second workpiece, according to an example.

### DETAILED DESCRIPTION

One of the variety of tools to shape or machine an unfinished product may be a milling machine. A milling machine may include a shaping mechanism to shape or machine the unfinished product. For example, the shaping mechanism may be a single milling bit. However, a single milling bit milling machine may not have the efficiency to be used in a mass production environment.

Examples described herein provide a milling machine with a first plurality of milling bits to cut a first workpiece and a second plurality of milling bits to cut a second workpiece. In an example, a milling machine may include a base and a receiving platform mounted to the base to receive a first workpiece and a second workpiece. The receiving platform may be moveable along a first axis. The milling machine may also include a support platform mounted to the base, a first plurality of milling bits to cut the first workpiece, and a second plurality of milling bits to cut the second workpiece. The first plurality of milling bits and the second plurality of milling bits may be moveable along a second axis via the support platform. Each milling bit of the first plurality of milling bits and the second plurality of milling bits may move along a third axis independently.

In another example, a milling machine may include a base and a receiving platform mounted to the base to receive a first workpiece and a second workpiece. The receiving platform may be moveable along a first axis. The milling machine may also include a support platform mounted to the base, a first plurality of milling bits to cut the first workpiece, and a second plurality of milling bits to cut the second workpiece. The first plurality of milling bits and the second plurality of milling bits may be moveable along a second axis via the pair of axial drives. Each milling bit of the first plurality of milling bits and the second plurality of milling bits may move along a third axis independently.

In another example, a non-transitory computer readable storage medium comprising instructions executable by a controller of a milling machine. The instructions when executed may cause the controller to divide a first workpiece into a first region and a second region; divide a second workpiece into a third region and a fourth region; determine a first cut path of a first milling bit of the milling machine based on the first region; determine a second cut path of a second milling bit of the milling machine based on the second region; determine a third cut path of a third milling bit of the milling machine based on the third region; determine a fourth cut path of a fourth milling bit of the milling machine based on the fourth region; perform, via the first milling bit and the second milling bit, a first cutting operation on the first workpiece based on the first cut path and the second cut path; and perform, via the third milling bit and the fourth milling bit, a second cutting operation on the second workpiece based on the third cut path and the fourth cut path. Thus, examples described herein may increase efficiency of a milling machine.

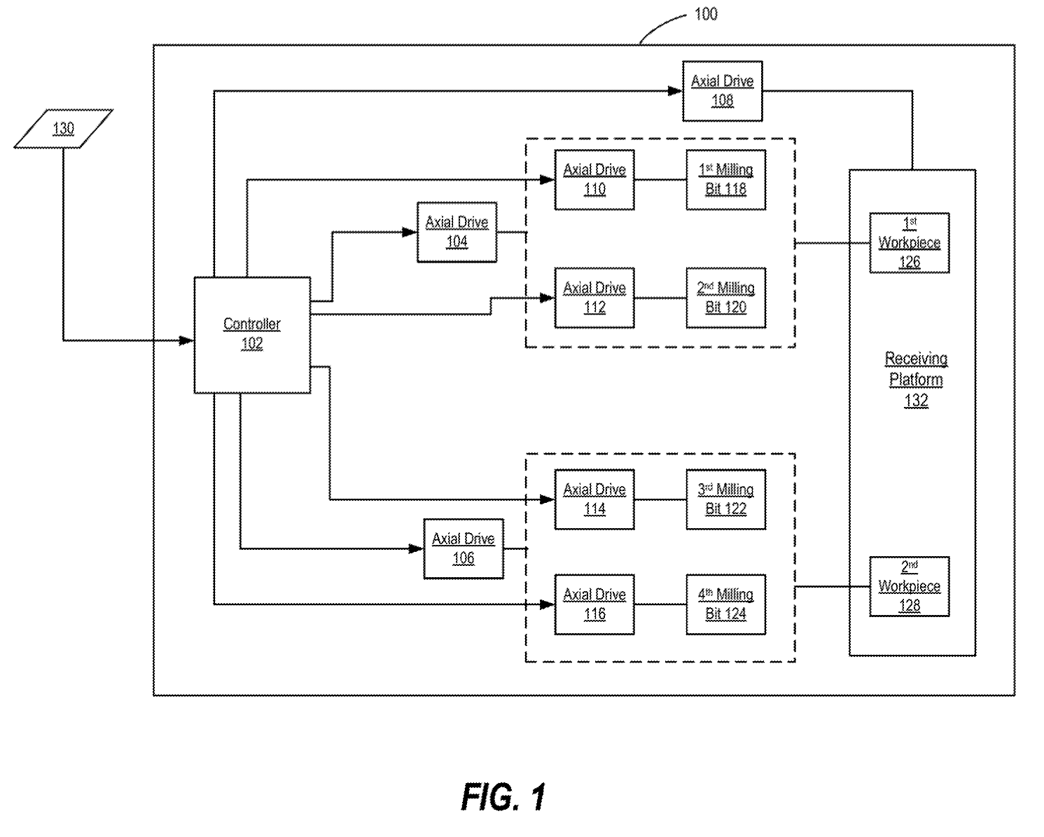

FIG. 1 illustrates a block diagram of a milling machine 100 with a first plurality of milling bits to cut a first workpiece and a second plurality of milling bits to cut a second workpiece, according to an example. Milling machine 100 may include a controller 102, axial drives 104-116, a first milling bit 118, a second milling bit 120, a third milling bit 122, a fourth milling bit 124, and a receiving platform 132.

Controller 102 may be a computing device and/or other hardware devices suitable to control a milling machine. Axial drives 104-116 may be devices for moving objects. For example, each of axial drive 104-116 may be implemented using a motor or an actuator.

Milling machine 100 may receive workpieces 126-128 at receiving platform 132 so that milling machine 100 may cut two workpieces simultaneously. For example, milling machine 100 may use a first plurality of milling bits to cut a first workpiece 126 and a second plurality of milling bits to cut a second workpiece 128. The first plurality of milling bits may correspond to first milling bit 118 and second milling bit 120. The second plurality of milling bits may correspond to third milling bit 122 and fourth milling bit 124. Each of workpieces 126 and 128 may be an object that is being cut by milling machine 100. For example, workpieces 126 and 128 may be raw material, such as metal or wood. As another example, workpieces 126 and 128 may be moldings that are to be shaped.

During operation, controller 102 may receive digital representations 130 of milled workpieces that are to be generated using workpieces 126 and 128. For example, workpieces 126 and 128 may be a pair of blank moldings for shoe lasts. Digital representations 130 may be three dimensional models of the pair of moldings with desired shapes. Each three dimensional model may be expressed as a set of coordinates in three axes (X-axis, Y-axis, and Z-axis).

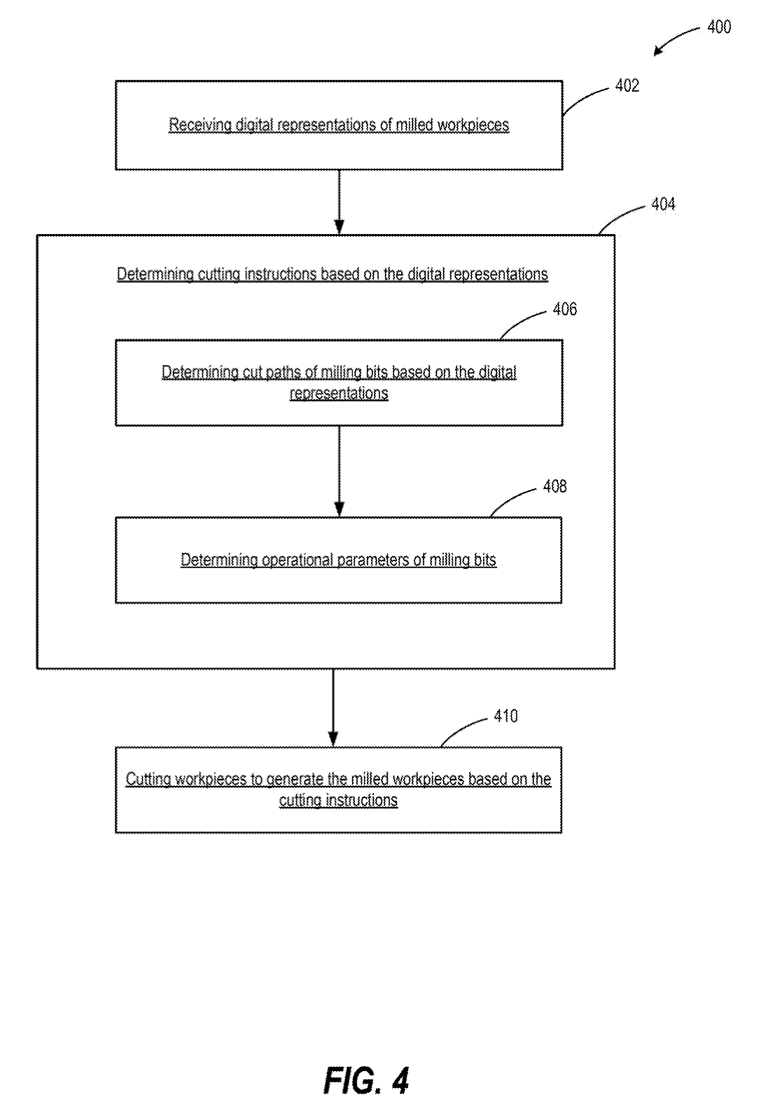

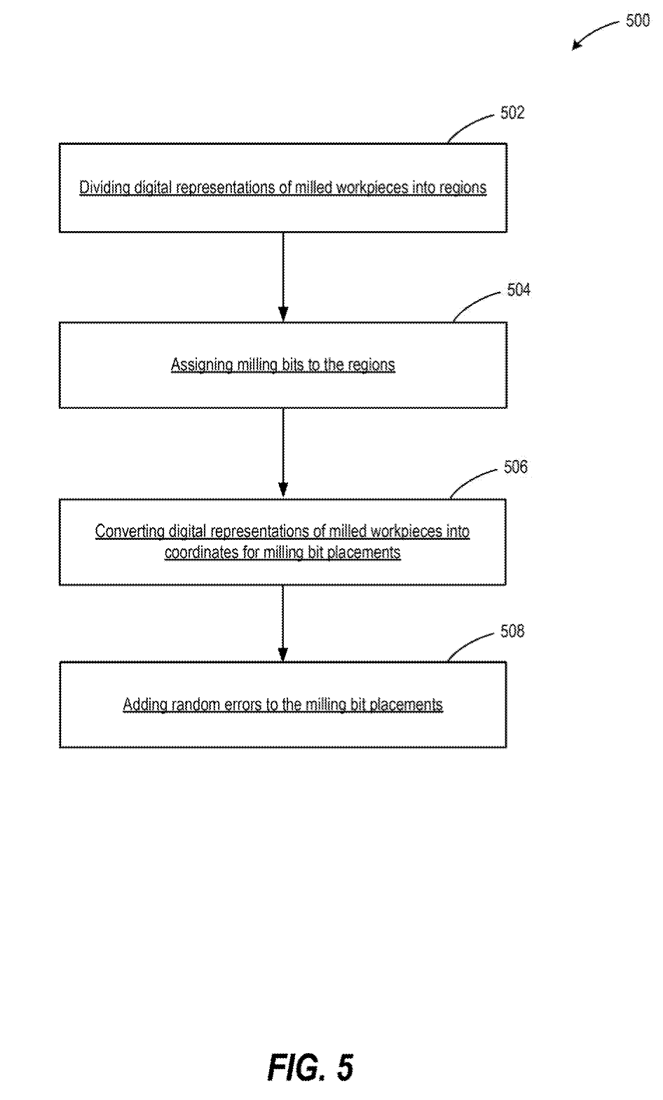

In response to receiving digital representations 130, controller 102 may determine cutting instructions for milling bits 118-124. Controller 102 may control milling bits 118-124 via axial drives 104-116 to cut workpieces 126-128. Cutting instruction determination is described in more detail in FIGS. 4-5.

Milling machine 100 may move milling bits 118-124 in three axes relative to workpieces 126 and 128. For example, axial drive 108 may be connected to receiving platform 132. Axial drive 108 may move receiving platform 132 along a first axis, such as Y axis. Axial drive 104 may be connected to milling bits 118-120 to move milling bits 118-120 along a second axis simultaneously, such as X-axis. Axial drive 106 may be connected to milling bits 122-124 to move milling bits 122-124 along the second axis simultaneously. Each of milling bits 118-124 may be connected to a distinct axial drive 110-116, respectively, to move independently along a third axis, such as Z axis. For example, axial drive 110 may move first milling bit 118 along Z axis while milling bits 120-124 may remain stationary. Thus, milling machine 100 may have seven degrees of movement to cut a pair of workpieces.

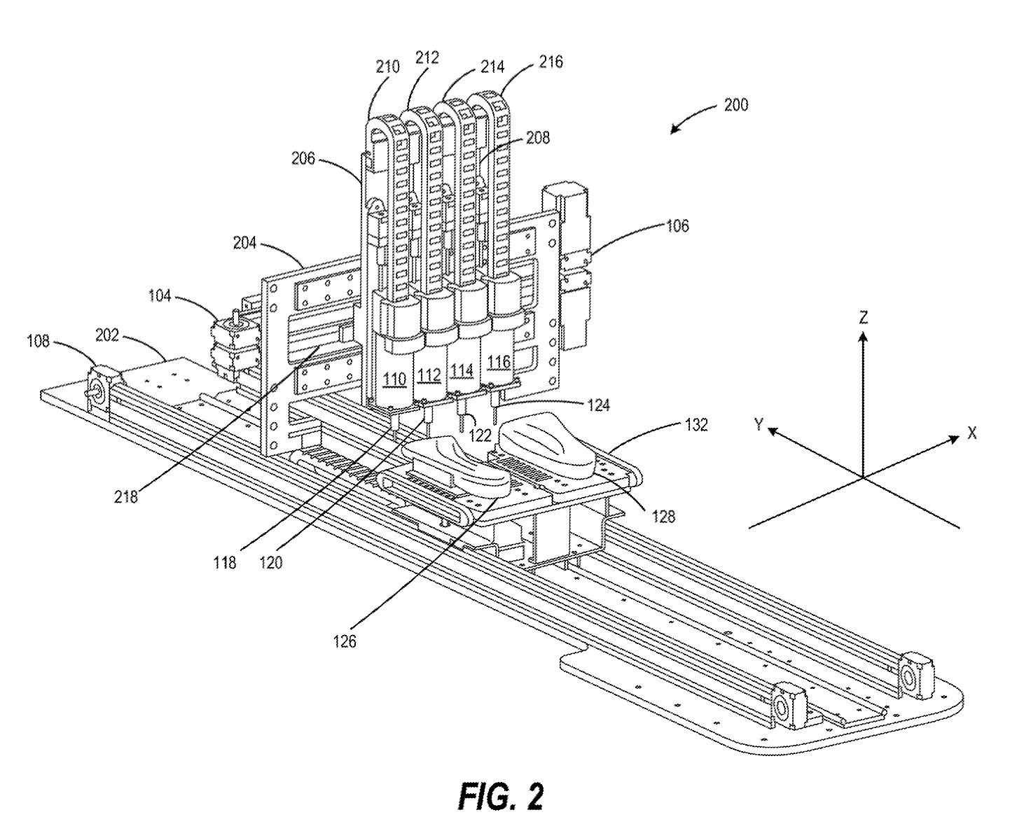

FIG. 2 illustrates an isometric view of a milling machine 200 with a first plurality of milling bits to cut a first workpiece and a second plurality of milling bits to cut a second workpiece, according to an example. Milling machine 200 may implement milling machine 100 of FIG. 1. Milling machine 200 may include a base 202, receiving platform 132, a support platform 204, and axial drives 104-116. Milling machine 200 may be controlled by a controller (not shown in FIG. 2), such as controller 102 of FIG. 1.

Receiving platform 132 may be mounted to base 202. Axial drive 108 may move receiving platform 132 with respect to base 202 along Y axis. As illustrated in FIG. 2, workpieces 126 and 128 may be received by receiving platform 132. Support platform 204 may be mounted to base 202 and may be perpendicular to receiving platform 132. Support platform 204 may provide structure support for milling bits 118-124 and axial drives 110-116. A pair of axial drives 104 and 106 may be mounted to support platform 204. Axial drive 104 may be connected to a first back plate 206 that supports milling bits 118-120 and axial drives 110-112. Thus, axial drive 104 may move milling bits 118-120 simultaneously along X-axis with respect to a track 218. Axial drive 106 may be connected to a second back plate 208 that supports milling bits 122-124 and axial drives 114-116. Thus, axial drive 106 may move milling bits 122-124 simultaneously along X-axis with respect to track 218.

Each of milling bits 118-124 may move independently along Z axis via a distinct rail 210-216, respectively. For example, axial drive 110 may be connected to first milling bit 118. Axial drive 110 may be mounted to rail 210. Thus, first milling bit 118 may move along Z axis via rail 210. Axial drive 112 may be connected to second milling bit 120. Axial drive 112 may be mounted to rail 212. Thus, second milling bit 120 may move along Z axis via rail 212. Axial drive 114 may be connected to third milling bit 122. Axial drive 114 may be mounted to rail 214. Thus, third milling bit 122 may move along Z axis via rail 214. Axial drive 116 may be connected to fourth milling bit 124. Axial drive 116 may be mounted to rail 216. Thus, fourth milling bit 124 may move along Z axis via rail 216.

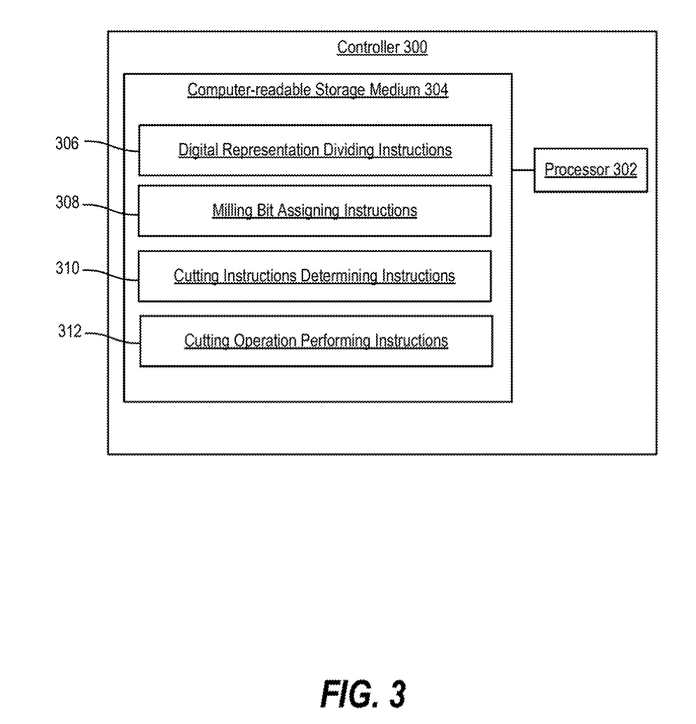

FIG. 3 illustrates a block diagram of controller 300 of a milling machine with a first plurality of milling bits to cut a first workpiece and a second plurality of milling bits to cut a second workpiece, according to an example. Controller 300 may implement controller 102 of FIG. 1. Controller 300 may implement as a controller for milling machine 200 of FIG. 2. Operations of controller 300 are described with reference to FIG. 1.

Controller 300 may include a processor 302 and a computer-readable storage medium 304. Processor 302 may be a central processing unit (CPU), a semiconductor-based microprocessor, and/or other hardware devices suitable for retrieval and execution of instructions stored in computer-readable storage medium 304. Processor 302 may fetch, decode, and execute instructions 306, 308, 310, and 312.

Computer-readable storage medium 304 may be any electronic, magnetic, optical, or other physical storage device that contains or stores executable instructions. Thus, computer-readable storage medium 304 may be, for example, Random Access Memory (RAM), an Electrically Erasable Programmable Read-Only Memory (EEPROM), a storage device, an optical disc, etc. In some examples, computer-readable storage medium 304 may be a non-transitory storage medium, where the term “non-transitory” does not encompass transitory propagating signals. As described in detail below, computer-readable storage medium 304 may be encoded with a series of processor executable instructions 306, 308, 310, and 312.

Workpiece dividing instructions 306 may divide digital representations 130 into different regions. For example, workpiece dividing instructions 306 may divide a first three dimensional model of a first milled workpiece into a first region and a second region. Workpiece dividing instructions 306 may also divide a second three dimensional model of a second milled workpiece into a third region and a fourth region.

Milling bit assigning instructions 308 may assign each of milling bits 118-124. For example, milling bit assigning instructions 308 may assign first milling bit 118 to the first region and second milling bit 120 to the second region. Milling bit assigning instructions 308 may also assign third milling bit 122 to the third region and fourth milling bit 124 to the fourth region. In some examples, a particular milling bit may be assigned to multiple regions.

Cutting instructions determining instructions 310 may determine cutting instructions for each of milling bits 118-124. The cutting instructions may include cut paths for each of milling bits 118-124, a distinct linear velocity of each of milling bits 118-124, and/or a distinct rotation speed of each of milling bits 118-124. Cutting operation performing instructions 312 may control milling bits 118-124 to cut workpieces 126 and 128 based on the cutting instructions.

FIG. 4 illustrates a method 400 of operation at a milling machine with a first plurality of milling bits to cut a first workpiece and a second plurality of milling bits to cut a second workpiece, according to an example. Method 400 may be implemented using milling machine 100 or milling machine 200. Method 400 is described with reference to FIG. 1.

Method 400 includes receiving digital representations of milling workpieces, at 402. For example, milling machine 100 may receive digital representations 130 of a pair of milled workpieces. Method 400 also includes determining cutting instructions based on the digital representations, at 404. Determining cutting instructions based on the digital representations includes determining cut paths of milling bits based on the digital representations, at 406. A cut path of a milling bit may indicate how the milling bit is to move along three axes. For example, milling machine 100 may determine cut paths for each of milling bits 118-124. In some example, milling machine 100 may use nearest neighbor analysis to determine the cut paths. An example of determining cut paths of milling bits based on the digital representations is described in more detail in FIG. 5.

Determining cutting instructions based on the digital representations also includes determining operational parameters, at 408. For example, milling machine 100 may determine linear velocity of each of milling bits 118-120 to ensure adequate chip clearing and to reduce the likelihood of over-friction of milling bits 118-120. Milling machine 100 may also determine rotation speed of each of milling bits 118-120. Method 400 further includes cutting workpieces to generate the milled workpieces based on the cutting instructions, at 410. For example, milling machine 100 may, based on cutting instructions generated by controller 102, cut workpieces 126-128 using milling bits 118-124 to generate milled workpieces represented in digital representations 130.

FIG. 5 illustrates a method 500 of determining cut paths of milling bits at a milling machine with a first plurality of milling bits to cut a first workpiece and a second plurality of milling bits to cut a second workpiece, according to an example. Method 500 may implement determining cut paths of milling bits based on the digital representations at 406 of method 400 of FIG. 4. Method 500 is described with reference to FIG. 1.

Method 500 includes dividing digital representations of milled workpieces into regions, at 502. For example, milling machine 100 may divide three dimensional models in digital representations 130 into multiple regions. Method 500 also includes assigning milling bits to the regions, at 504. For example, milling machine 100 may assign first milling bit 118 to the first region and second milling bit 120 to the second region. Milling machine 100 may also assign third milling bit 122 to the third region and fourth milling bit 124 to the fourth region.

Method 500 further includes converting digital representations of milled workpieces into coordinates for milling bit placements, at 506. For example, milling machine 100 may covert sets of coordinates in three axes used to describe the three dimensional models of milled workpieces in digital representations 130 to coordinates in three axes to describe placements of milling bits 118-124 (e.g., how each milling bit 118-124 is to move in X-axis, Y axis, and Z axis). Method 500 further includes adding random errors to the milling bit placements, at 508. For example, milling machine 100 may add at least a distinct random error to each distinct determined milling bit placement of milling bit 118-124 along X-axis.

The use of “comprising”, “including” or “having” are synonymous and variations thereof herein are meant to be inclusive or open-ended and do not exclude additional unrecited elements or method steps.

What is claimed is:

1. A milling machine comprising:
a base;
a receiving platform mounted to the base to receive a first workpiece and a second workpiece, wherein the receiving platform is moveable along a first axis;
a support platform mounted to the base;
a first plurality of milling bits to cut the first workpiece; and
a second plurality of milling bits to cut the second workpiece, wherein the first plurality of milling bits and the second plurality of milling bits are moveable along a second axis via the support platform, and wherein each milling bit of the first plurality of milling bits and the second plurality of milling bits is to move along a third axis independently.

2. The milling machine of claim 1, wherein the first axis corresponds to a Y-axis relative to the receiving platform, wherein the second axis corresponds to a X-axis relative to the receiving platform, and wherein the third axis corresponds to a Z-axis relative to the receiving platform.

3. The milling machine of claim 1, wherein the support platform is perpendicular to the receiving platform.

4. The milling machine of claim 1, wherein the first plurality of milling bits is to move simultaneously along the second axis, and wherein the second plurality of milling bits is to move simultaneously along the second axis.

5. The milling machine of claim 1, further comprising a distinct rail for each milling bit of the first plurality of milling bits and the second plurality of milling bits.

6. A milling machine comprising:
a base;
a receiving platform mounted to the base to receive a first workpiece and a second workpiece, wherein the receiving platform is moveable along a first axis;
a support platform mounted to the base;
a pair of axial drives mounted to the support platform;
a first plurality of milling bits to cut the first workpiece; and
a second plurality of milling bits to cut the second workpiece, wherein the first plurality of milling bits and the second plurality of milling bits are moveable along a second axis via the pair of axial drives, and wherein each milling bit of the first plurality of milling bits and the second plurality of milling bits is to move along a third axis independently.

7. The milling machine of claim 6, wherein the first axis corresponds to a Y-axis relative to the receiving platform, wherein the second axis corresponds to a X-axis relative to the receiving platform, and wherein the third axis corresponds to a Z-axis relative to the receiving platform.

8. The milling machine of claim 6, wherein the pair of axial drives includes a first axial drive and a second axial drive, wherein the first axial drive is to move the first plurality of milling bits simultaneously along the second axis, and wherein the second axial drive is to move the second plurality of milling bits simultaneously along the second axis.

9. The milling machine of claim 8, wherein the first axial drive is to move the first plurality of milling bits independently from the second plurality of milling bits.

10. The milling machine of claim 6, further comprising a distinct rail for each milling bit of the first plurality of milling bits and the second plurality of milling bits.

11. A non-transitory computer-readable storage medium comprising instructions that when executed cause a controller of a milling machine to:
divide digital representations of a pair of milling workpieces into a plurality of regions including a first region, a second region, a third region, and a fourth region;
assign a first plurality of milling bits of the milling machine to the first region and the second region;
assign a second plurality of milling bits of the milling machine to the third region and the fourth region;
determine cutting instructions of the first plurality of milling bits and the second plurality of milling bits based on the plurality of regions;
perform, via the first plurality of milling bits, a first cutting operation on a first workpiece based on the cutting instructions; and
perform, via the second plurality of milling bits, a second cutting operation on a second workpiece based on the cutting instructions.

12. The non-transitory computer-readable storage medium of claim 11, wherein the instructions when executed further cause the controller to determine operational parameters associated with the first plurality of milling bits and the second plurality of milling bits.

13. The non-transitory computer-readable storage medium of claim 12, wherein the operational parameters include a distinct linear velocity and a distinct rotation speed associated with each of the first plurality of milling bits and the second plurality of milling bits.

14. The non-transitory computer-readable storage medium of claim 11, wherein the instructions when executed further cause the controller to determine a cut path of a particular milling bit of the milling machine based on a region of a workpiece and a random error.

15. The non-transitory computer-readable storage medium of claim 11, wherein the instructions when executed further cause the controller to determine a cut path of a particular milling bit of the milling machine using a nearest neighbor analysis.
